(19) United States
(12) Patent Application Publication
(10) Pub. No.: US 2002/0154881 A1
(43) Pub. Date: Oct. 24, 2002

(54) Communications dead end

(76) Inventor: Robert De France, Poughkeepsie, NY (US)

Correspondence Address: ALIX YALE & RISTAS LLP, 750 MAIN STREET, SUITE 1400, HARTFORD, CT, 06103, US

(21) Appl. No.: 09/838,446

(22) Filed: Apr. 19, 2001

(51) Int. Cl. G02B 6/00; F16L 3/00

(52) U.S. Cl. 385/136; 248/316.1; 248/74.1; 248/74.4

(57) ABSTRACT

A dead end connector for an associated cable having (a) an axially extending communications cable and (b) an axially extending messenger wire. The communications cable and the messenger wire have respective axial parts fixed together. The dead end connector includes a body having a first elongated axially extending trough defined therein. The first trough is dimensioned and configured for receiving an axial section of the associated data cable and communicates with a face of the body to define an entrance to the trough along the face. The first trough is dimensioned and configured for receiving axial portions of both the communications cable and the messenger wire of an associated data cable in some forms of the invention. The body may further include a second trough dimensioned and configured for receiving the messenger wire. The first trough and the second trough may each have an axis and the axis of the first trough may be parallel to the axis of the second trough and the first trough and the second trough may each be symmetrical about a common plane.

### BACKGROUND OF THE INVENTION

The invention relates to connectors for anchoring the end of a communications cable to a support. One application for the apparatus of the present invention is for anchoring the end of a communications data cable at the side of a residential or commercial building to which data and communications services are provided by the cable.

Data cables, are unable to sustain the relatively large forces that may occur in typical installations. The loads created by the weight of the cable extending between two supports as well as the loads created by winds and ice are substantial.

Data cables typically utilize at least one axially extending strength member in combination with one or more axially extending communications cables that are fixed to the strength member. The strength member is also referred to as the messenger wire. A wide range of data cables for a large variety of applications has been employed over the years. Typical data cables have a maximum rated cable tension of 2,880 lbs. and a typical cable may weigh between 27 and 130 pounds per 1000 feet.

One popular industry standard data cable has a cross-section that is substantially the same as the numeral 8. In this cable the smaller diameter circular portion of the numeral 8-shaped cross-section includes the messenger wire or support wire. The larger diameter circular portion of the numeral 8 shaped cross-section of data cable typically includes one or more communication cables therein.

Because of the vital importance of the maintenance of communication links and because of the vast amounts of information that can be transferred through such cables reliability is of great importance in all apparatus that might affect such communications. Accordingly, reliability is of great importance in the present apparatus.

### SUMMARY OF THE INVENTION

An object of the invention is to provide a new and improved dead end connector that may be efficiently used with a messenger cable. Another object of the invention is to provide a dead end connector that is a very reliable.

Still another object of the invention is to provide apparatus that is easy to install even in conjunction with an eyebolt.

A further object of the invention is to provide a dead end connector that has a low cost construction and provides a connection having mechanical integrity. It has now been found that these and other objects of the invention may be attained in a dead end connector for an associated data cable having (a) an axially extending communications cable and (b) a messenger wire. The communications cable and the messenger wire have respective axial parts fixed together. The dead end connector includes a body having a first elongated axially extending trough defined therein. The first trough is dimensioned and configured for receiving an axial section of the associated data cable and communicates with a face of the body to define an entrance to the trough along the face.

The first trough is also dimensioned and configured for receiving axial portions of both the communications and the cable portion of an associated cable in some forms of the invention. In some forms of the invention the body may further include a second trough dimensioned and configured for receiving the messenger wire. The first trough and the second trough may each have an axis and the axis of the first trough may be parallel to the axis of the second trough, and the first trough and the second trough may each be symmetrical about a common plane.

The dead end connector may further include first and second cylindrical section shaped ears and a lanyard and apparatus for coupling the lanyard to the body. The first and second cylindrical section shaped ears are disposed on opposite sides of the first trough in some forms of the invention and they may include axially extending slots in some forms of the invention.

### BRIEF DESCRIPTION OF THE DRAWING

The invention will be better understood by reference to the accompanying drawing in which:

FIG. 1 is a side view of a dead and connector in accordance with one embodiment of the invention.

FIG. 2 is a cross-section view taken along the line 2-2 of FIG. 1.

FIG. 3 is the top view of the apparatus illustrated FIG. 1.

FIG. 4 is a cross-section view of a typical messenger cable.

FIG. 5 is a cross-section view of the apparatus illustrated in FIG. 1 taken along a plane P that bisects the communications dead end 10 to define two symmetrical halves.

FIG. 6 is a partially schematic view of an axial section of a data cable mounted in a communications dead end having the lanyard thereof positioned for engagement with a hook that is not shown.

### DESCRIPTION OF THE PREFERRED EMBODIMENT

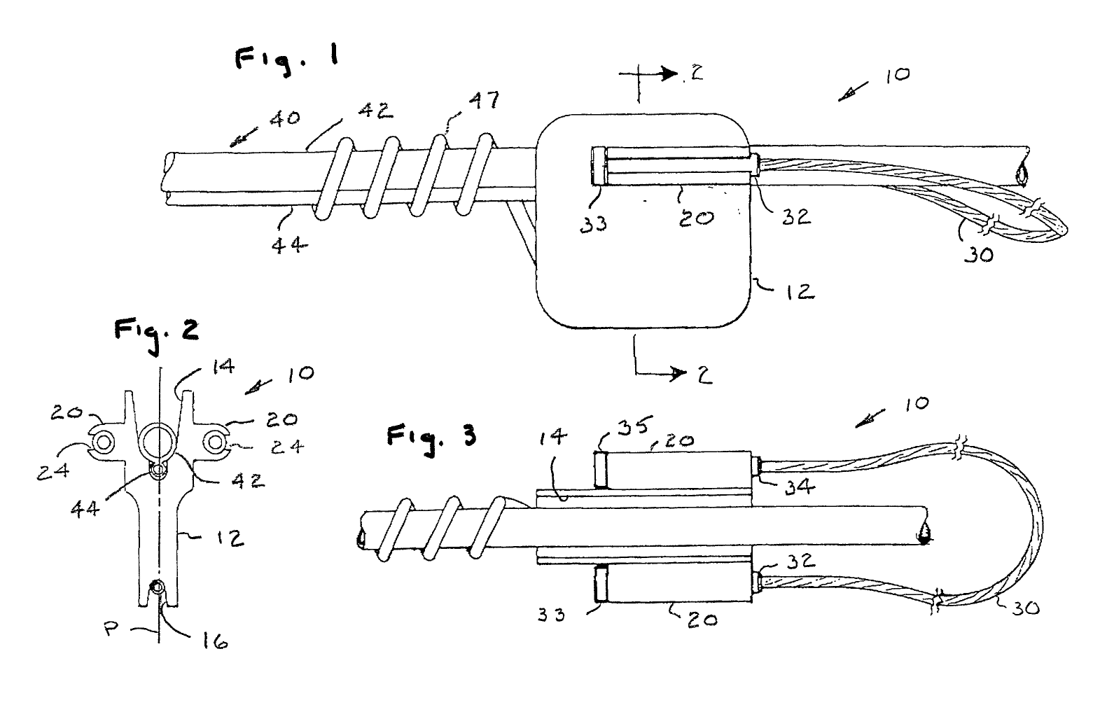

Referring now to FIGS. 1-6, there is shown a communications dead end 10 having a body 12. The body 12 has a first generally U-shaped slot 14 extending along the entire upper surface of the body 12. A second U-shaped slot 16 extends along the entire bottom extent of the body 12. The slots 14, 16 are disposed in opposed relationship with the respective openings of the U-shaped slots 14, 16 on opposed top and bottom surfaces of the body 12 in the preferred embodiment. More particularly, each slot 14, 16 is symmetrical about a common central plane P (shown in FIG. 2). The body 12 includes first and second cylindrical section shaped ears 20, 20 disposed on opposed sides of both the central plane P and the body 1 2. Each cylindrical section shaped ear 20, 20 is provided with an axially extending slot 24. Each axially extending slot 24 is disposed at the part of each cylindrical section shaped ear 20 that is furthest from the central plane P. The respective axes of the cylindrical section shaped ears 20 are (a) parallel (b) coplanar and (c) parallel to the plane P in the preferred embodiment.

The communications dead end 10 includes a braided steel cable or lanyard 30 having first and second ferrules 32, 34 disposed at the axial extremities of the lanyard 30. The ferrules 32, 34 are provided with respective flanges 33, 35 disposed at the axial extremities of both of the lanyard 30 and ferrules 32, 34. The ferrules 32, 34 surround the entire circumference of the lanyard 30 and are typically crimped, soldered or welded to the lanyard 30. Thus, the diameter of the ferrules 32, 34 is greater than the diameter of the lanyard 30. The slots 24 are dimensioned and configured to allow passage of an axial section of the lanyard 30 but not any axial part of the ferrules 32, 34 to pass into or out of the interior of the cylindrical section shaped years 20. Similarly, the flanges 33, 35 are dimensioned and configured to abut an axial extremity of the respective cylindrical section shaped ears 20.

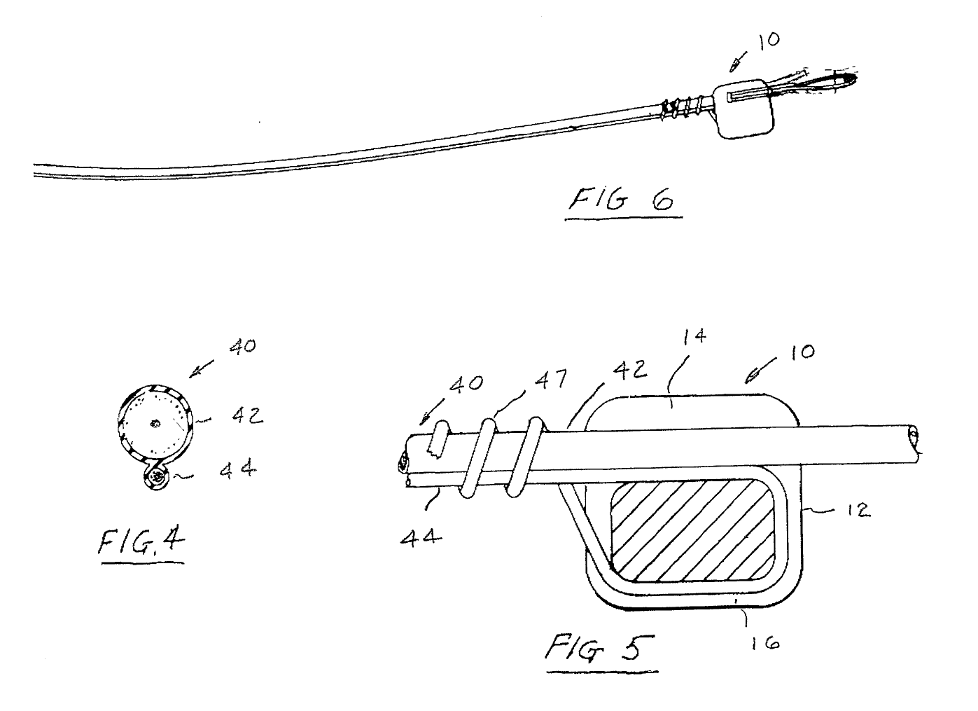

As shown in FIGS. 1-6 and particularly in FIGS. 2 and 4, a data cable 40, having a cross-section that is substantially the shape of the numeral 8 is engaged with the communications dead end 10. The data cable 40 includes a generally circular axially extending communications cable 42 to, which is fixed, throughout the entire axial extent thereof, a messenger wire 44. The messenger wire 44 may be stainless steel or other high-strength material that is typically covered by an insulating sheath.

In normal practice, the installer will first separate approximately a six inch axial portion of the axial extremity of the messenger wire 44 from the communications cable 42. Thereafter, the installer will then place the data cable 40 into the trough defined by the first U-shaped slot 16 with the numeral 8 cross-section of the data cable 40 oriented in the manner illustrated in FIG. 2. More particularly, the messenger wire 44 is positioned below the communications cable 42 with an axial part of the messenger wire 44 (that is about seven inches from the axial extremity of the data cable 40) resting in the slot 14 of the communications dead end 10. The installer will then bend the six inch axial portion of the axial extremity of the messenger wire 44 that has been previously separated from the data cable 40 to position the messenger wire 44, to extend completely through the slot 14, downwardly to the right (as viewed) extremity of the slot 16, along the entire axial extent of the slot 16, and then wrapped around the data cable 40 in a series of coils 47 as best seen in FIGS. 1, 5, and 6. The U-shaped slot 14 ordinarily will have a depth of about 20 mm and a maximum width of about 9 mm.

Accordingly, a dead end 10 engages a length of the data cable 40. The messenger wire 44 that is part of the data cable 40 is secured to the dead end 10. The dead end connector 10 has cylindrical section shaped ears 20. The cylindrical section shaped ears 20 cooperate with the lanyard or bail 30 by means of the ferrules 32 provided with flanges 35 that abut an extremity of each ear 20. Thus, a very positive mounting of the data cable 40 is possible with the lanyard 30.

A design consideration for mountings for data cable is the sensitivity of some data cables to damage in the event the body is bent excessively. In other words, the radius of curvature that is possible without damage to the data cable is severely limited. Advantageously, the apparatus of the present invention provides a very positive mounting for the data cable and completely avoids bending of the data cable 40. As will be apparent from the drawings, only the messenger wire 44 is twisted or bent during installation or any other time. Because the messenger wire 44 is manufactured of steel or other strong material that is not sensitive to damage from bending, the dead end connector 10 in accordance with present invention avoids the problem of damage to the communications cable 42.

The lanyard or bail 30 as well as the ferrules 33, 35 are preferably manufactured of stainless steel to ensure a long service life. The body 12 is preferably manufactured of a nylon glass filled material having a construction with a generous radius of curvature on each corner to prevent any possible damage to the communications cable 42. The nylon glass filled composition of the body 12 is advantageous because it will not corrode and because it is an electrical insulator and thus ensures there will be no electrical interference. In the preferred embodiment of the lanyard or bail 30 is removable from the body 12.

This is advantageous because it enables an installer to engage even eyebolts or to wrap the lanyard 30 around a given fixed object. Advantageously, lanyards of various lengths may be provided for the convenience of an installer connecting the body 12 in different environments. Although other forms of the present invention may alternatively use a rigid bail. The groove 14 is preferably dimensioned generously to accommodate any one of various data cables 40 having a substantial dimension range. Another advantageous aspect of the apparatus of the present invention is that as the load due to the weight of the data cables 40 increases, the tension on the messenger wire 44 increases, causing the coils 47 to tighten and thereby grip the data cable 40 even more firmly.

Although the invention has been described with respect to any messenger cable having a cross-section resembling the numeral 8, it will be understood that the invention has application to data cables having other exterior contours, such as a single cylindrical cross-section. For example, the trough (defined in present invention by the U-shaped slot 14) will accommodate a wide range of cable sizes and shapes. Similarly, although the invention has been described with respect to a 20 cable intended for communications of any kind, it will be understood by those skilled in the art that the invention also has application to cables for other applications.

While the preferred embodiment of the present invention has been shown and described, various modifications and substitutions may be made thereto without departing from the spirit and scope of the invention. Accordingly, it is to be understood that the present invention has been described by way of illustration and not limitation.

What is claimed:

1. A dead end connector for an associated data cable comprising an axially extending communication cable and an axially extending messenger wire, wherein the dead end connector comprises: a body having a first elongated axially extending trough defined therein, said first trough being dimensioned and configured for receiving an axial section of the associated messenger cable, said first trough communicating with a face of said body to define an entrance to said first trough along the face, said body further including a second trough dimensioned and configured for receiving the messenger wire, and further including a lanyard and means for coupling said lanyard to said body at opposed transversely spaced locations relative to said first trough.

2. A dead end connector for an associated messenger cable in accordance with claim 1, wherein said first trough and said second trough each have an axis and the axis of said first trough is parallel to the axis of said second trough.

3. A dead end connector for an associated messenger cable in accordance with claim 1, wherein said first trough and said second trough are each symmetrical about a common plane.

4. A dead end connector for an associated messenger cable in accordance with claim 1, wherein said means for coupling includes first and second cylindrical section shaped ears.

5. A dead end connector for an associated messenger cable in accordance with claim 4, wherein said first and second cylindrical section shaped ears are disposed on opposite sides of said first trough.

6. A dead end connector for an associated messenger cable in accordance with claim 5, wherein said first and second cylindrical section shaped ears include axially extending slots.

7. A dead end connector for an associated messenger cable in accordance with claim 5, further including a lanyard and means for coupling said lanyard to said first and second cylindrical section shaped ears.

8. A dead end connector for an associated messenger cable in accordance with claim 2, wherein said first trough and said second trough are each symmetrical about a common plane.

9. A dead end connector for an associated data cable in accordance with claim 8, wherein said body includes first and second cylindrical section shaped ears.

10. A dead end connector for an associated data cable in accordance with claim 9, wherein said first and second cylindrical section shaped ears are disposed on opposite sides of said first trough.

11. A dead end connector for an associated data cable in accordance with claim 10, wherein first and second cylindrical section shaped ears include axially extending slots.

12. A dead end connector for an associated data cable in accordance with claim 11 further including a lanyard and means for coupling said lanyard to said first and second cylindrical section shaped ears.
